(19) United States
(12) Patent Application Publication
(10) Pub. No.: US 2020/0126124 A1
(43) Pub. Date: Apr. 23, 2020

(54) INFORMATION PROCESSING APPARATUS, INFORMATION PROCESSING SYSTEM AND ADVERTISEMENT DISTRIBUTION METHOD

(71) Applicant: TOYOTA JIDOSHA KABUSHIKI KAISHA, Toyota-shi (JP)

(72) Inventors: Hiroto INOUE, Nagakute-shi (JP); Masatoshi HAYASHI, Nisshin-shi (JP); Shugen YAMAMURA, Nagoya-shi (JP); Kosuke YOSHIDA, Nagakute-shi (JP); Yoshino YAMAMORI, Nagoya-shi (JP)

(73) Assignee: TOYOTA JIDOSHA KABUSHIKI KAISHA, Toyota-shi (JP)

(21) Appl. No.: 16/587,783

(22) Filed: Sep. 30, 2019

(30) Foreign Application Priority Data
Oct. 4, 2018 (JP) 2018-189186

(51) Int. Cl. G06Q 30/02; G07C 5/00

(52) U.S. Cl. CPC G06Q 30/0266; G06Q 2240/00; G07C 5/008

(57) ABSTRACT

An information processing system including: a road-side apparatus installed at an entrance or an exit of a toll road or a facility, the road-side apparatus being configured to perform predetermined wireless communication with an in-vehicle apparatus in a vehicle passing through the entrance or the exit; and a server is provided. The server includes a control unit configured to: if passage of the vehicle through the entrance or the exit is detected by the road-side apparatus, acquire destination information relating to a destination of the vehicle and state information relating to a state of the vehicle from the in-vehicle apparatus; select advertisement information to be distributed to the vehicle, based on the destination information; determine whether or not a predetermined condition for ensuring safety of running of the vehicle is satisfied, based on the state information; and if the predetermined condition is satisfied, distribute the advertisement information to the vehicle.

### CROSS REFERENCE TO RELATED APPLICATION

This application claims the benefit of Japanese Patent Application No. 2018-189186, filed on Oct. 4, 2018, which is hereby incorporated by reference herein in its entirety.

### BACKGROUND

### Technical Field

The present disclosure relates to an information processing apparatus, an information processing system and an advertisement distribution method.

### Description of the Related Art

Advertisement distribution systems in which when a vehicle with an in-vehicle device mounted therein enters an entrance gate of a toll road, a road-side machine installed at a toll booth transmits advertisement data relating to a facility located at a destination through the toll road or along the toll road to the in-vehicle device and the in-vehicle device causes the advertisement data to be displayed on a display unit of a navigation apparatus are disclosed (for example, Patent Document 1). Also, advertisement distribution systems in which a lane device stores advertisement data and distribution designation information distributed from an upper node and when a vehicle passes through a gate of a toll booth, reads user information recorded in an ETC card and selectively distributes advertisement data based on comparison between the user information and the distribution designation information for the stored advertisement data are disclosed (for example, Patent Document 2).

### CITATION LIST

### Patent Document

Patent document 1: Japanese Patent Laid-Open No. 2002-269607
Patent document 2: Japanese Patent Laid-Open No. 2009-064076

However, in the conventional techniques, each time a vehicle that is a target of distribution of advertisement passes through a gate, advertisement is distributed to the vehicle, and thus, depending on the state of the vehicle, for example, distribution of advertisement may hinder safe running of the vehicle. Also, in a case where distribution of advertisement hinders running of the vehicle, effectiveness of the advertisement may also be lowered.

An object of an aspect of the disclosure is to provide an information processing apparatus, an information processing system and an advertisement distribution method that when advertisement is distributed to a vehicle, enable ensuring both advertising effectiveness and safety of running of the vehicle.

### SUMMARY

An aspect of the present disclosure is

an information processing apparatus including a processor configured to:

acquire, when passage of a vehicle through an entrance or an exit of a toll road is detected, destination information relating to a destination of the vehicle and state information relating to a state of the vehicle;

select advertisement information to be distributed to the vehicle, based on the destination information;

determine whether or not a predetermined condition for ensuring safety of running of the vehicle is satisfied, based on the state information; and

distribute, when the predetermined condition is satisfied, the advertisement information to the vehicle.

An aspect of the present disclosure is an information processing system including:

a road-side apparatus installed at an entrance or an exit of a toll road or a facility, the road-side apparatus being configured to perform predetermined wireless communication with an in-vehicle apparatus in a vehicle passing through the entrance or the exit; and

a server,

wherein the server includes a processor configured to:

acquire, when passage of the vehicle through the entrance or the exit is detected via the wireless communication between the road-side apparatus and the vehicle, destination information relating to a destination of the vehicle and state information relating to a state of the vehicle;

select advertisement information to be distributed to the vehicle, based on the destination information;

determine whether or not a predetermined condition for ensuring safety of running of the vehicle is satisfied, based on the state information; and

distribute, when the predetermined condition is satisfied, the advertisement information to the vehicle.

An aspect of the present disclosure is

an advertisement distribution method including:

acquiring, when passage of a vehicle through an entrance or an exit of a toll road is detected, destination information relating to a destination of the vehicle and state information relating to a state of the vehicle;

selecting advertisement information to be distributed to the vehicle, based on the destination information;

determining whether or not a predetermined condition for ensuring safety of running of the vehicle is satisfied, based on the state information; and

distributing, when the predetermined condition is satisfied, the advertisement information to the vehicle.

The present disclosure enables, when advertisement is distributed to a vehicle, ensuring both advertising effectiveness and safety of running of the vehicle.

### BRIEF DESCRIPTION OF DRAWINGS

FIG. 1 is a diagram illustrating an example of a system configuration of an advertisement distribution system according to a first embodiment;

FIG. 2 is a diagram illustrating respective example of hardware configurations of the center server, a road-side apparatus and an in-vehicle apparatus in the advertisement distribution system;

FIG. 3 is a diagram illustrating respective examples of functional configurations of the center server, a road-side apparatus and an in-vehicle apparatus in the advertisement distribution system;

FIG. 4 is an example of a flowchart of processing in the road-side apparatus;

FIG. 5 is an example of a flowchart of processing in the center server; and

FIG. 6 is a diagram illustrating an example of a sequence of processing in the advertisement distribution system.

### DESCRIPTION OF THE EMBODIMENTS

An aspect of the present disclosure is an information processing apparatus including a processor configured to: acquire, when passage of a vehicle through an entrance or an exit of a toll road is detected by a road-side apparatus installed at the entrance or the exit of the toll road, destination information relating to a destination of the vehicle and state information relating to a state of the vehicle; select advertisement information to be distributed to the vehicle, based on the destination information; determine whether or not a predetermined condition for ensuring safety of running of the vehicle is satisfied, based on the state information; and distribute, when the predetermined condition is satisfied, the advertisement information to the vehicle.

According to the present disclosure, advertisement information based on destination information is distributed to a vehicle, enabling drawing attention of occupants in the vehicle and thus enabling enhancement in advertising effectiveness. Also, advertisement is distributed to the vehicle when a predetermined condition for ensuring safety of running of the vehicle is satisfied, enabling ensuring safety of running of the vehicle. Also, the advertisement information is distributed to the vehicle when passage of the vehicle is detected by a road-side apparatus installed at an entrance or an exit of a toll road, and thus, the advertisement information can be distributed at a timing before arrival of a destination during the vehicle running on the toll road on a route to the destination, enabling enhancement in advertising effectiveness.

In the aspect of the present disclosure, the state information may include a speed of the vehicle. In this case, the predetermined condition may be that the speed of the vehicle is equal to or below a predetermined value. If the speed of the vehicle is low, for example, safe running is highly likely to be continued even if a driver of the vehicle sees the advertisement information.

In the aspect of the present disclosure, the state information may include the number of occupants in the vehicle. In this case, the predetermined condition may be that two or more occupants are in the vehicle. The driver is included in the occupants in the vehicle. Two or more occupants being in the vehicle indicates that there is an occupant other than the driver. Therefore, for example, even though the driver does not see the distributed advertisement information, the occupant other than the driver is highly likely to see the advertisement information, enabling enhancement in advertising effectiveness. Also, even if the driver is distracted by the advertisement information, the passenger can give care to running of the vehicle, enabling ensuring safety of running of the vehicle.

In the aspect of the present disclosure, the vehicle may be an autonomous vehicle. Also, the state information may include information indicating whether or not the vehicle is in automatic operation. In this case, the predetermined condition may be that the vehicle is in automatic operation. During automatic operation of the autonomous vehicle, for example, even if all the occupants including the driver pay attention to the distributed advertisement information, safety of running of the vehicle can be ensured.

In the aspect of the present disclosure, the processor may select advertisement information related to a predetermined range including the destination indicated by the destination information, as the advertisement information to be distributed to the vehicle. The predetermined range including the destination is, for example, a range of a predetermined distance from the destination, a city, a ward, a town or a village or a town section that is the same as the destination, or the city, the ward, the town or the village and a city, a ward, a town or a village surrounding the city, the ward, the town or the village. Examples of the advertisement information related to the predetermined range include, e.g., advertisement information of a shop or a facility located in the predetermined range and advertisement information of specialty products and famous local products of a city, a ward, a town or a village located in the predetermined range. Since the destination is a place the vehicle is heading for, distribution of the advertisement information related to the predetermined range including the destination enabling drawing attention of occupants in the vehicle and thus enabling enhancement in advertising effectiveness.

In the aspect of the present disclosure, the destination information may include identification information of the exit the vehicle passes through. In this case, the processor may select advertisement information related to a predetermined range positioned in a direction of exit from the exit the vehicle passes through, as the advertisement information to be distributed to the vehicle. Since the vehicle passes through the predetermined range positioned in the direction of exit from the exit of the toll road after passage through the exit, the advertisement information can be distributed just before the passage of the predetermined range, enabling enhancement in advertising effectiveness.

In the following, an embodiment of the present disclosure will be described with reference to the drawings. The configuration of the embodiment described below is an example, and the present disclosure is not limited to the configuration of the embodiment.

### First Embodiment

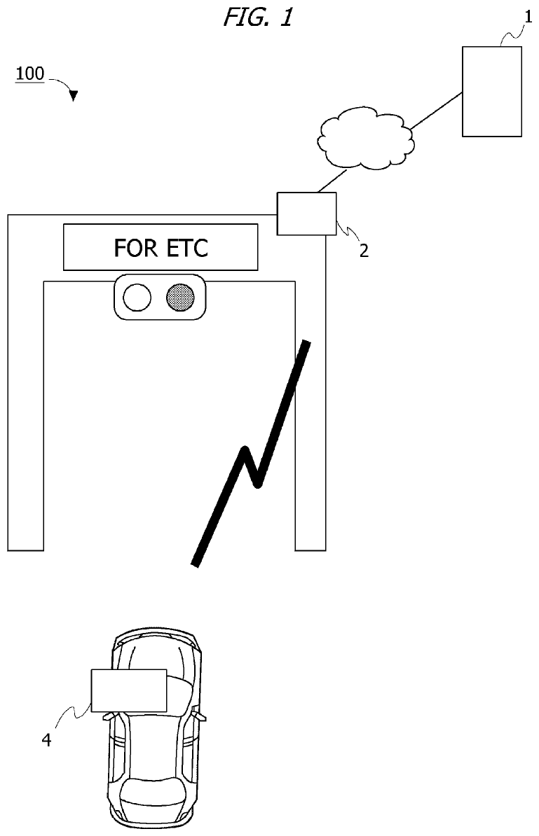

FIG. 1 is a diagram illustrating an example of a system configuration of an advertisement distribution system 100 according to a first embodiment. The advertisement distribution system 100 is a system that, for example, when a vehicle passes through an entrance or an exit of a toll road, makes a determination to distribute advertisement information selected according to a destination of the vehicle to the vehicle, depending on a state of the vehicle. In the first embodiment, a case where a vehicle passes through an exit gate of an expressway as an example of an entrance or an exit of a toll road will be described. The exit gate of the expressway is an example of “exit” of “toll road”.

The advertisement distribution system 100 includes, for example, a center server 1, a road-side apparatus 2 installed in the vicinity of an exit gate of an expressway and an in-vehicle apparatus 4 mounted in a vehicle. In FIG. 1, for simplicity of illustration, one road-side apparatus 2 and one in-vehicle apparatus 4 are extracted and illustrated. A plurality of road-side apparatuses 2 and a plurality of in-vehicle apparatuses 4 are included in the advertisement distribution system 100, respectively. Each road-side apparatus 2 is associated with, for example, one exit gate of an expressway and is installed at the associated exit gate. Note that although in FIG. 1, the road-side apparatus 2 is installed at an upper part of the exit gate, a position at which a road-side apparatus 2 is installed is not limited to the position illustrated in FIG. 1.

The road-side apparatus 2 and the in-vehicle apparatus 4 are, for example, apparatuses also included in an ETC system (electronic toll collection system) of expressways. The in-vehicle apparatus 4 is, for example, an ETC in-vehicle device. The road-side apparatus 2 and the in-vehicle apparatus 4 perform wireless communication with each other according to, for example, a short-distance wireless communication method such as DSRC (dedicated short-range communications). The road-side apparatus 2 transmits a signal including identification information of the gate with which the road-side apparatus 2 is associated (at which the road-side apparatus 2 is installed), in a predetermined interval. Note that the vehicle with the in-vehicle apparatus 4 mounted therein may be an autonomous vehicle.

The road-side apparatus 2 and the center server 1 are each connected to a network, for example, the Internet and can communicate with each other via the network.

In the ETC system, for example, the following processing is performed. For example, when a vehicle passes through an entrance gate of an expressway, a relevant in-vehicle apparatus 4 receives a signal transmitted from a road-side apparatus installed in the vicinity of the entrance gate and based on the reception of the signal, records an entry to the expressway. More specifically, the in-vehicle apparatus 4 creates and stores entrance information including identification information of the entrance gate included in the signal transmitted from the road-side apparatus and a time of the reception of the signal as a time of the passage through the entrance gate.

When the vehicle passes through an exit gate of the expressway, the in-vehicle apparatus 4 receives a signal transmitted from a road-side apparatus 2 installed in the vicinity of the exit gate and thereby detects the passage through the exit gate and the road-side apparatus 2. The in-vehicle apparatus 4 transmits, for example, the entrance information, an ETC card number and vehicle information to the road-side apparatus 2. The vehicle information includes, for example, an automobile registration number indicated on a number plate and vehicle type information. Upon reception of these information pieces from the in-vehicle apparatus 4, the road-side apparatus 2 acquires a toll based on the entrance information and the vehicle information and transmits information of the toll to a predetermined settlement server and the in-vehicle apparatus 4. In this way, expressway tolls are collected in the ETC system. The settlement server is, for example, a server of a company of a credit card used for expressway toll payment in the ETC system.

In the first embodiment, for example, information of each user that permits distribution of advertisement from the advertisement distribution system 100 and information relating to a vehicle used by the user are registered. Upon detection of a road-side apparatus 2 installed in the vicinity of an exit gate, an in-vehicle apparatus 4 mounted in a vehicle registered in the advertisement distribution system 100 transmits, for example, information used for acquisition of an expressway toll such as entrance information, an advertisement permission message, vehicle state information relating to a state of the vehicle and destination information relating to a destination to the road-side apparatus 2. The advertisement permission message is, for example, a message indicating that the vehicle permits distribution of advertisement from the advertisement distribution system 100 through the road-side apparatus 2. The vehicle state information includes, for example, a speed of the vehicle, the number of occupants in the vehicle, and if the vehicle is an autonomous vehicle, information indicating whether or not the vehicle is in automatic operation. Note that no destination information may be transmitted from the in-vehicle apparatus 4 to the road-side apparatus 2. The destination information is an example of “destination information”. The vehicle state information is an example of “state information”.

Upon reception of the advertisement permission message, etc., from the in-vehicle apparatus 4, the road-side apparatus 2 transmits an advertisement acquisition request for requesting advertisement information acquisition to be transmitted to the in-vehicle apparatus 4, to the center server 1. The vehicle state information and the destination information of the vehicle are transmitted together with the advertisement acquisition request. Also, the road-side apparatus 2 acquires an expressway toll for the vehicle with the in-vehicle apparatus 4 mounted therein. Note that if no destination information is received from the in-vehicle apparatus 4, for example, the road-side apparatus 2 transmits gate identification information of the exit gate as destination information.

The center server 1 includes, for example, a database that stores advertisement information associated with map information. Upon reception of the advertisement acquisition request from the road-side apparatus 2, the center server 1 acquires advertisement information according to the destination information received together with the advertisement acquisition request, from the database. Also, in order to determine whether or not to distribute advertisement to the vehicle with the in-vehicle apparatus 4 mounted therein, for example, the center server 1 determines whether or not an advertisement distribution condition is met, based on the vehicle state information. The advertisement distribution condition is a condition for determining that if advertisement is distributed to the vehicle, safety of the occupants in the vehicle can be ensured. The advertisement distribution condition is, for example, one or any combination of, e.g., the speed of the vehicle being equal or below a predetermined value, two or more occupants being in the vehicle, and if the vehicle is an autonomous vehicle, the vehicle being in automatic operation. The advertisement distribution condition is an example of “predetermined condition for ensuring safety of running of the vehicle”.

Also, the center server 1 acquires discount information for the expressway toll for the vehicle with the in-vehicle apparatus 4 mounted therein. If the advertisement distribution condition is met, the center server 1 makes a determination to distribute advertisement to the vehicle with the in-vehicle apparatus 4 mounted therein and transmits the advertisement information according to the destination information of the vehicle and the discount information to the road-side apparatus 2.

Upon reception of the advertisement information and the discount information from the center server 1, for example, the road-side apparatus 2 re-acquires an expressway toll based on the discount information and transmits information of the discounted expressway toll and the advertisement information to the in-vehicle apparatus 4.

Upon reception of the information of the discounted expressway toll and the advertisement information from the road-side apparatus 2, the in-vehicle apparatus 4 outputs the information of the expressway toll and the advertisement information to a display apparatus in the vehicle to cause the information of the expressway toll and the advertisement information to be displayed on the display apparatus. The display apparatus in the vehicle may be, for example, a display apparatus in a car navigation system or may be a display apparatus that is separate from a car navigation system. Also, for example, the advertisement information may be displayed after display of the expressway toll.

In the first embodiment, advertisement information according to a destination a vehicle is heading for is distributed and thus can draw attention of occupants in the vehicle, enabling enhancement in advertising effectiveness. Also, in the first embodiment, when an advertisement distribution condition is met, that is, when safety of occupants in a vehicle can be ensured even though advertisement is distributed, advertisement is distributed to the vehicle, enabling suppression of occurrence of hindrance to running of the vehicle due to distribution of advertisement to the vehicle. Note that in the first embodiment, “transmit advertisement or advertisement information to an in-vehicle apparatus 4” is also referred to as “distribute advertisement or advertisement information to a vehicle with an in-vehicle apparatus 4 mounted therein” or is also simply referred to as “distribute advertisement or advertisement information to a vehicle”.

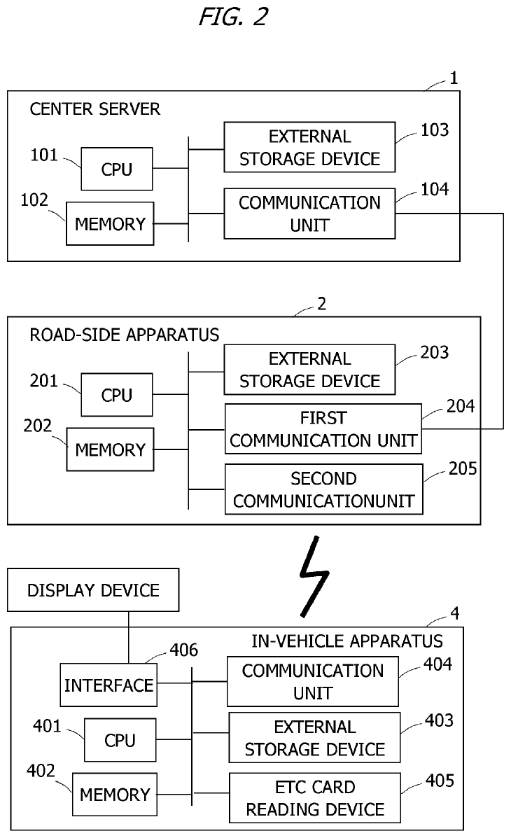

FIG. 2 is a diagram illustrating respective example of hardware configurations of the center server 1, a road-side apparatus 2 and an in-vehicle apparatus 4 in the advertisement distribution system 100. The center server 1 is, for example, a special-purpose computer or a general-purpose computer. The center server 1 includes a CPU (central processing unit) 101, a memory 102, an external storage device 103 and a communication unit 104 as the hardware configuration. Each of the memory 102 and the external storage device 103 is a computer-readable recording medium. The center server 1 is an example of “information processing apparatus”.

The external storage device 103 stores various programs and data that the CPU 101 uses in executing the respective programs. The external storage device 103 is, for example, an EPROM (erasable programmable ROM) or a hard disc drive. Examples of the programs held in the external storage device 103 include an operating system (OS), a control program for the advertisement distribution system 100 and various other application programs. The control program for the advertisement distribution system 100 is a program for determining advertisement information according to a destination of a vehicle and determining whether or not to distribute the advertisement information to the vehicle according to a state of the vehicle.

The memory 102 is a main memory that provides a memory area and a work area for the CPU 101 to load a program stored in the external storage device 103 and is used as a buffer. The memory 102 includes, for example, a semiconductor memory such as a ROM (read-only memory) or a RAM (random access memory).

The CPU 101 performs various types of processing by loading the OS and various application programs held in the external storage device 103 to the memory 102 and executing the OS and various application programs. The number of CPUs 101 is not limited to one and a plurality of CPUs 101 may be provided. The CPU 101 is an example of “processor”.

The communication unit 104 is an interface via which information are input/output from/to a network. The communication unit 104 may be an interface that connects to a wired network or an interface that connects to a wireless network. Examples of the communication unit 104 include, e.g., an NIC (network interface card) or a wireless circuit.

Next, the road-side apparatus 2 includes, for example, a CPU 201, a memory 202, an external storage device 203, a first communication unit 204 and a second communication unit 205 as hardware components. The CPU 201, the memory 202 and the external storage device 203 are similar to the CPU 101, the memory 102 and the external storage device 103, respectively. A control program for a road-side apparatus 2 in the advertisement distribution system 100 is stored in the external storage device 203 of the road-side apparatus 2. The control program for a road-side apparatus 2 in the advertisement distribution system 100 stored in the external storage device 203 is a program for requesting advertisement information to be distributed to a vehicle passing through an exit gate associated with the road-side apparatus 2 from the center server 1 and transmitting the advertisement information received from the center server 1 to the vehicle according to an advertisement permission message received from the vehicle.

The first communication unit 204 is an interface via which information is input/output to/from a network and is communicable with the center server 1 through the network. The first communication unit 204 may be an interface that connects to a wired network or an interface that connects to a wireless network. Examples of the first communication unit 204 include, e.g., an NIC (network interface card) and a wireless circuit.

The second communication unit 205 performs communication according to a predetermined short-distance wireless communication method. For example, the second communication unit 205 performs communication according to DSRC. For example, the second communication unit 205 transmits a signal including identification information of an exit gate in a predetermined interval. Upon reception of, e.g., a connection request from a reception apparatus that has received the signal, the second communication unit 205 establishes a session with the reception apparatus and performs communication with the reception apparatus. In the first embodiment, the reception apparatus that receives the signal transmitted by the second communication unit 205 is an in-vehicle apparatus 4. Note that the short-distance wireless communication method executed by the second communication unit 205 is not limited to DSRC but may be, for example, Wi-Fi Direct, BLUETOOTH (registered trademark) or BLE (Bluetooth Low Energy).

Next, the in-vehicle apparatus 4 is, for example, an ETC in-vehicle device. Where the vehicle is an autonomous vehicle, the in-vehicle apparatus 4 may be an automatic driving control apparatus including a function that communicates with a road-side apparatus 2. Note that the in-vehicle apparatus 4 is not limited to these examples, but may be, for example, any apparatus that has a function that communicates with a road-side apparatus 2 and can control a display apparatus installed in the vehicle.

The in-vehicle apparatus 4 include, for example, a CPU 401, a memory 402, an external storage device 403, a communication unit 404, an ETC card reading device 405 and an interface 406 as hardware components. The CPU 401, the memory 402 and the external storage device 403 are similar to the CPU 101, the memory 102 and the external storage device 103, respectively. However, a control program for an in-vehicle apparatus in the advertisement distribution system 100 is stored in the external storage device 403 of the in-vehicle apparatus 4. The control program for an in-vehicle apparatus in the advertisement distribution system 100 is, for example, a program for receiving distribution of advertisement through a road-side apparatus 2 at the time of passage through an exit gate.

The communication unit 404 performs communication according to a predetermined short-distance wireless communication method that is the same as that of the road-side apparatuses 2. For example, the communication unit 404 performs communication according to DSRC. The communication unit 404 performs signal reception processing in a predetermined interval, and for example, upon reception of a signal transmitted from a road-side apparatus 2, notifies the CPU 401 of the reception of the signal. Subsequently, for example, the communication unit 404 establishes a session with the road-side apparatus 2 according to an instruction from the CPU 401 and transmits/receives data to/from the road-side apparatus 2 according to the predetermined short-distance wireless communication method.

The ETC card reading device 405 includes an ETC card slot, and reads information recorded in an ETC card inserted in the slot and outputs the information to the CPU 401 according to, for example, an instruction from the CPU 401. The ETC card is equipped with, for example, an IC chip. In the IC chip, for example, an ETC card number and vehicle information of a vehicle associated with the ETC card are recorded. User identification information in the advertisement distribution system 100 may also be recorded in the IC chip of the ETC card. However, the present disclosure is not limited to this example and the user identification information in the advertisement distribution system 100 may be stored in, for example, the external storage device 403. The ETC card number is a unique number assigned to the ETC card and includes an identification number of an ETC card issuing company such as a credit card company and a user identification number.

The vehicle information includes, for example, a vehicle type (e.g., a standard-sized vehicle or a large-size vehicle) and a vehicle identification number. The vehicle identification information recorded in the ETC card may be, for example, an automobile registration number indicated on a number plate. The user identification information in the advertisement distribution system 100 may be, for example, any of, e.g., user identification information that is common with the ETC system, a name or a company name of the user and identification information uniquely assigned in the advertisement distribution system 100. Also, the ETC card number may be used as the user identification information and in this case, no ETC card number may separately be transmitted as user identification information together with, e.g., entrance information to a road-side apparatus 2.

The interface 406 is, for example, an interface for connection with the display apparatus equipped in the vehicle.

Note that the hardware configuration of the center server 1, the road-side apparatus 2 and the in-vehicle apparatus 4 illustrated in FIG. 2 is a mere example and is not limited to the example and appropriate omission, replacement and addition of components are possible according to the embodiment. For example, the center server 1 may include a removable recording medium drive device and execute a program recorded in a removable recording medium. The removable recording medium is, for example, a recording medium such as an SD card, a mini SD card, a micro SD card, a USB (universal serial bus) flash memory, a CD (compact disc), a DVD (digital versatile disc), a Blu-ray (registered trademark) disc or a flash memory card. Also, for example, the center server 1 may include an input device and an output device. Examples of the input device include, e.g., a keyboard, a mouse and a touch panel. Examples of the output device include, e.g., a display.

Note that a series of processing performed in the center server 1, the road-side apparatus 2 and the in-vehicle apparatus 4 can be implemented not just by execution of software by the processor but also by, for example, hardware such as an FPGA (field-programmable gate array).

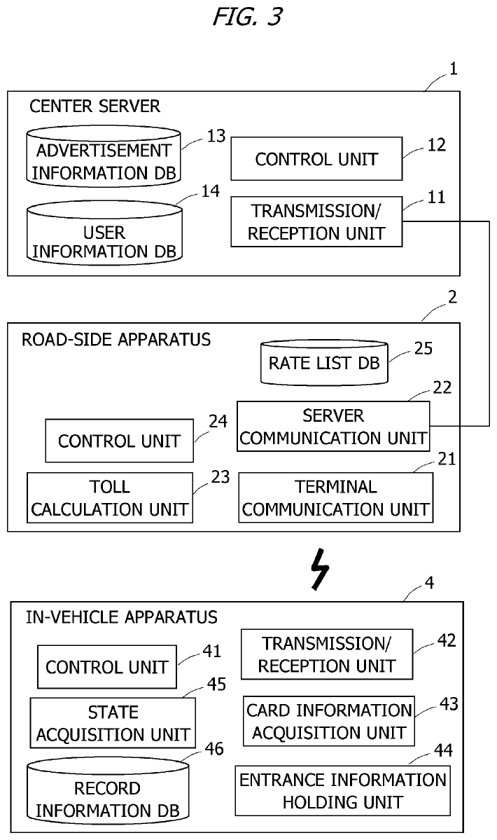

FIG. 3 is a diagram illustrating respective examples of functional configurations of the center server 1, a road-side apparatus 2 and an in-vehicle apparatus 4 in the advertisement distribution system 100. The in-vehicle apparatus 4 includes a control unit 41, a transmission/reception unit 42, a card information acquisition unit 43, an entrance information holding unit 44, a state acquisition unit 45 and a record information database (DB) 46 as functional components. These functional components are implemented, for example, by execution of a control program for an in-vehicle apparatus 4 in the advertisement distribution system 100, the control program being stored in the external storage device 403, by the CPU 401 of the in-vehicle apparatus 4.

The transmission/reception unit 42 is an interface for communication with a road-side apparatus 2, the communication being performed via the communication unit 404. Upon reception of a signal transmitted from a road-side apparatus 2 through the communication unit 404, the transmission/reception unit 42 controls establishment of a session with the road-side apparatus 2. For example, the transmission/reception unit 42 outputs data received from the road-side apparatus 2 through the communication unit 404 to the control unit 41. Also, for example, the transmission/reception unit 42 transmits data input from the control unit 41 through the communication unit 404 to the road-side apparatus 2.

The card information acquisition unit 43 acquires, for example, information recorded in an ETC card from the ETC card reading device 405 and outputs the information to the control unit 41 according to an instruction from the control unit 41. The entrance information holding unit 44 is created in, for example, a memory area of the memory 402 and holds entrance information. Note that recording and deletion of entrance information in/from the entrance information holding unit 44 are performed by, for example, the control unit 41.

The state acquisition unit 45 acquires vehicle state information, for example, in a predetermined interval. For example, if a speed of the vehicle is included in the vehicle state information, the state acquisition unit 45 may acquire the speed of the vehicle from a speed meter equipped in the vehicle or may acquire the speed of the vehicle by acquiring position information from position information acquisition means in the GPS (global positioning system). For example, if the number of occupants in the vehicle is included in the vehicle state information, the state acquisition unit 45 may acquire the number of occupants in the vehicle from an input by an occupant in the vehicle or may acquire information acquired by a sensor in the vehicle. The sensor in the vehicle is, for example, a camera installed so as to face an interior space of the vehicle. For example, if information indicating whether or not the vehicle is in automatic operation is included in the vehicle state information, the state acquisition unit 45 may acquire whether or not the vehicle is in automatic operation from a control apparatus that controls driving. For example, the state acquisition unit 45 outputs latest vehicle state information to the control unit 41 according to an instruction from the control unit 41.

The control unit 41 receives an input of gate identification information included in a signal received from a road-side apparatus 2, from the transmission/reception unit 42. For example, whether a gate associated with the road-side apparatus 2 is an entrance gate or an exit gate can be determined from the gate identification information. If the control unit 41 detects that the gate associated with the road-side apparatus 2 that is a transmission source of the gate identification information is an entrance gate, from the gate identification information, the control unit 41 acquires a time of passage through the entrance gate and, for example, stores entrance information including the gate identification information of the entrance gate and the time of passage in the entrance information holding unit 44.

If the control unit 41 detects that the gate associated with the road-side apparatus 2 that is a transmission source of the gate identification information is an exit gate, from the gate identification information, the control unit 41 performs the following processing. First, the control unit 41 provides an instruction to establish a session with the road-side apparatus 2 to the transmission/reception unit 42. Also, the control unit 41 causes the gate identification information of the exit gate and a time of reception of the signal as a time of passage through the gate to be held as exit information in the entrance information holding unit 44.

Next, the control unit 41 provides an instruction to read information from the ETC card to the card information acquisition unit 43 to acquire, e.g., an ETC card number and vehicle information from the card information acquisition unit 43. If user identification information is recorded in the ETC card, the user identification information is also acquired from the ETC card. Next, the control unit 41 acquires entrance information from the entrance information holding unit 44. Next, the control unit 41 acquires vehicle state information from the state acquisition unit 45. Next, the control unit 41 acquires destination information. The destination information may be, for example, information of a destination set in a car navigation system or information of a destination set in the in-vehicle apparatus 4 by an occupant of the vehicle. The information of the destination may be, for example, any of an address, a name of a building and a latitude and a longitude. The control unit 41 outputs the entrance information, the ETC card number, the vehicle information, the user identification information, an advertisement permission message, the vehicle state information and the destination information to the transmission/reception unit 42 to transmit these information pieces to the road-side apparatus 2 through the transmission/reception unit 42. Note that if no destination is set in the car navigation system or the in-vehicle apparatus 4 and thus no destination information can be acquired, no destination information may be transmitted.

Also, the control unit 41 receives an input of expressway toll information received from the road-side apparatus 2 and advertisement information, from the transmission/reception unit 42. The control unit 41 outputs the received expressway toll information and the received advertisement information to a display apparatus equipped in the vehicle and causes these information pieces to be displayed on the display apparatus. The control unit 41 acquires the entrance information and exit information from the entrance information holding unit 44 and stores these information pieces in the record information DB 46 together with the toll information. Also, the control unit 41 deletes the entrance information and the exit information held in the entrance information holding unit 44 for refresh.

In the record information DB 46, expressway use record information is stored. In the expressway use record information, for example, entrance information, exit information and toll information are stored in association with one another.

Next, the road-side apparatus 2 includes a terminal communication unit 21, a server communication unit 22, a toll calculation unit 23, a control unit 24 and a rate list DB 25 as functional components. These functional components are functional components implemented by execution of a control program for a road-side apparatus 2 in the advertisement distribution system 100, the control program being stored in the external storage device 203, by the CPU 201 of the road-side apparatus 2.

The terminal communication unit 21 controls communication with an in-vehicle apparatus 4, the communication being performed through the second communication unit 205. For example, the terminal communication unit 21 provides an instruction to cause the second communication unit 205 to transmit a signal including gate identification information of a gate associated with the road-side apparatus 2 in a predetermined interval. Also, the terminal communication unit 21 receives a request such as a connection request from an in-vehicle apparatus 4 that has received the signal and controls establishment of a session with the in-vehicle apparatus 4. Upon reception of, e.g., entrance information, an ETC card identification number, vehicle information, user identification information, an advertisement permission message, vehicle state information and destination information from the in-vehicle apparatus 4, the terminal communication unit 21 outputs these information pieces to the control unit 24. Also, for example, upon input of expressway toll information and advertisement information from the control unit 24, the terminal communication unit 21 transmits these information pieces to the in-vehicle apparatus 4 through the second communication unit 205.

The server communication unit 22 controls communication with the center server 1 and other servers, the communication being performed through the first communication unit 204. For example, upon reception of an input of the advertisement permission message, the vehicle state information and the destination information received from the in-vehicle apparatus 4, from the control unit 24, the server communication unit 22 transmits the vehicle state information, the destination information and the user identification information to the center server 1 together with an advertisement acquisition request. For example, upon reception of advertisement information according to the destination information received from the in-vehicle apparatus 4 and discount information, from the center server 1, the server communication unit 22 outputs these information pieces to the control unit 24.

For example, the toll calculation unit 23 calculates an expressway toll according to an instruction from the control unit 24. The expressway toll is calculated based on, for example, a rate list stored in the rate list DB 25 and the entrance information and the vehicle information received from the in-vehicle apparatus 4.

The control unit 24 performs control relating to the advertisement distribution system 100 in the road-side apparatus 2. Details are as follows. Upon receipt of an input of the advertisement permission message, etc., received from the in-vehicle apparatus 4, from the terminal communication unit 21, the control unit 24 outputs the advertisement acquisition request, the vehicle state information, the destination information and the user identification information to the server communication unit 22 to transmit these information pieces to the center server 1 through the server communication unit 22. If no destination information is received from the in-vehicle apparatus 4, the control unit 24 acquires the gate identification information of the exit gate associated with the relevant apparatus as destination information and transmits the gate identification information to the center server 1 together with the advertisement permission message.

Also, upon reception of an input of the user identification information, the entrance information and the vehicle information received from the in-vehicle apparatus 4, from the terminal communication unit 21, the control unit 24 provides an instruction to acquire expressway toll information to the toll calculation unit 23 and acquires information of an expressway toll from the toll calculation unit 23.

Also, the control unit 24 receives an input of the advertisement information and the discount information received from the center server 1, from the server communication unit 22. The control unit 24 acquires a toll resulting from a predetermined amount being subtracted from the expressway toll acquired from the toll calculation unit 23 based on the discount information. The control unit 24 outputs information of the discounted expressway toll and the advertisement information to the terminal communication unit 21 to transmit these information pieces to the in-vehicle apparatus 4 through the terminal communication unit 21. Also, the control unit 24 outputs the information of the discounted expressway toll to the server communication unit 22 to transmit the information to a settlement server through the server communication unit 22 and perform processing for settlement of the expressway toll. The settlement server is, for example, a server of a credit card company identified from an ETC card number of an ETC card registered for expressway toll payment.

The rate list DB 25 is created in, for example, a memory area of the external storage device 203 in the road-side apparatus 2. The rate list DB 25 holds, for example, an expressway toll rate list.

An expressway toll is determined according to, for example, a distance between an entrance gate and an exit gate the vehicle passed through and the type of the vehicle. Therefore, the expressway toll rate list held in the rate list DB 25 holds, for example, association among identification information pieces of entrance gates, vehicle types and tolls. However, the expressway toll rate list held in the rate list DB 25 is not limited to this example.

Next, the center server 1 includes a transmission/reception unit 11, a control unit 12, an advertisement information DB 13 and a user information DB 14 as functional components. These functional components are implemented by, for example, execution of a control program for the center server 1 in the advertisement distribution system 100, the control program being stored in the external storage device 103, by the CPU 101 of the center server 1.

The transmission/reception unit 11 controls communication with a road-side apparatus 2 and other servers, the communication being performed through the communication unit 104. For example, upon reception of an advertisement acquisition request, vehicle state information, destination information and user identification information from a road-side apparatus 2, the transmission/reception unit 11 outputs these information pieces to the control unit 12. Also, for example, upon reception of an input of advertisement information according to the destination information received from the road-side apparatus 2 and discount information, from the control unit 12, the transmission/reception unit 11 transmits these information pieces to the road-side apparatus 2. Also, the transmission/reception unit 11 transmits advertisement fee information to a predetermined server. The predetermined server is, for example, a server of a company of a credit card registered for advertisement fee payment by an advertiser of the advertisement information according to the destination information.

The control unit 12 receives an input of the vehicle state information and the destination information received from the road-side apparatus 2, from the transmission/reception unit 11. The control unit 12 acquires the advertisement information according to the destination information from the later-described advertisement information DB 13. For example, the control unit 12 acquires advertisement information associated with a predetermined range including a destination indicated by the destination information, from the advertisement information DB 13. If there are a plurality of the associated advertisement information pieces, for example, the control unit 12 may extract, e.g., an advertisement information piece associated with a spot closest to the destination or an advertisement information piece registered in association with the vehicle which a user is most interested in. Examples of the predetermined range including the destination include, e.g., a range of a predetermined distance from the destination, a district, such as a city, a ward, a town or a village or a town section, in which the destination is located, and a city, a ward, a town or a village in which the destination is located and a city, a ward, a town or a village surrounding the city, the ward, the town or the village.

For example, if the destination information includes gate identification information of an exit gate, the control unit 12 acquires advertisement information associated with a predetermined range positioned in a direction of exit from the exit gate, from the advertisement information DB 13. The identification information and position information of the exit gate are, for example, stored in advance in a memory area of the external storage device 103. Examples of the predetermined range positioned in the direction of exit from the exit gate is include, e.g., a range of a predetermined distance in a direction of exit from the exit gate, a district, such as a city, a ward, a town or a village or a town section, positioned in the direction of exit from the exit gate, and a city, a ward, a town or a village positioned in the direction of exit from the exit gate and a city, a ward, a town or a village surrounding the city, the ward, the town or the village.

Also, the control unit 12 determines whether or not the vehicle state information satisfies an advertisement distribution condition, and if the advertisement distribution condition is satisfied, the control unit 12 makes a determination to distribute advertisement to the vehicle. Example of the advertisement distribution condition include, e.g., a speed of the vehicle being equal to or below a predetermined value, two or more users being in the vehicle and if the vehicle is an autonomous vehicle, the vehicle being in automatic operation.

Where the speed of the vehicle is equal to or below the predetermined value, driving is less likely to be hindered even if a driver of the vehicle sees advertisement information. Where two or more users are in the vehicle, a user other than the driver is in the vehicle, advertisement information can be provided to the user other than the driver though the driver does not see the advertisement information. Also, even if the driver is distracted by the advertisement information, the other user can warn the driver, enabling ensuring safety of running of the vehicle. Where the vehicle is in automatic operation, for example, the driver affords to see advertisement information, enabling ensuring safety of running of the vehicle.

Also, upon making a determination to distribute advertisement to the vehicle, the control unit 12 stores the user identification information and the advertisement information to be distributed in association with each other as record information of advertisement information to be distributed to the vehicle, in the later-described user information DB 14.

Also, the control unit 12 acquires expressway toll discount information accompanying reception of advertisement. The expressway toll discount information accompanying reception of advertisement is, for example, either a discount amount or a discount rate. The discount information may be determined, for example, based on a rate list set in advance based on, e.g., the number of advertisement distributions to the vehicle or a total number of hours of advertisements distributed. Also, a discount amount or a discount rate may be set in advance for each advertisement distribution. Also, the rate list may be set in advance for each user rank. Note that the method for determining expressway toll discount information accompanying reception of advertisement is not limited to these examples.

The control unit 12 outputs the advertisement information and the discount information to the transmission/reception unit 11 to transmit the advertisement information and the discount information to the road-side apparatus 2 through the transmission/reception unit 11. Also, the control unit 12 performs advertisement fee settlement processing for an advertiser of the advertisement information at a predetermined timing, for example, each time advertisement information is displayed or once a month. In the first embodiment, an advertisement fee for an advertiser is determined based on expressway toll discount information for a vehicle accompanying distribution of the advertiser's advertisement information to the vehicle. In the advertisement fee settlement processing, for example, the control unit 12 transmits information of advertisement fees for each advertiser to a settlement server that performs advertisement fee settlement. The settlement server that performs advertisement fee settlement is, for example, a server of a company of a credit card registered for use in settlement. For example, if a timing for advertisement fee settlement processing is a predetermined interval such as once a mouth, a total amount of advertisement fees in one period is transmitted.

The advertisement information DB 13 and the user information DB 14 are created in, for example, a recording area of the external storage device 103 in the center server 1. In the advertisement information DB 13, each advertisement information piece is stored in association with identification information and map information of a relevant advertiser. More specifically, for example, if advertisement information relates to, e.g., a shop or a facility, the advertisement information is stored in association with an address of the shop or the facility on a map in the advertisement information DB 13. For example, if advertisement information relates to specialty products and famous local products of a region, the advertisement information is stored in association with the region in the advertisement information DB 13. Advertisement information is, for example, a file of, e.g., a still image or a moving image. The still image or the moving image may be provided with sound.

Also, in the advertisement information DB 13, for example, information relating to each advertiser is also stored. The information relating to each advertiser includes, e.g., identification information of the advertiser and advertisement fee settlement information. Examples of the advertisement fee settlement information include, e.g., a credit card number to be used for advertisement fee payment and a bank account number to be used for withdrawal for advertisement fee payment.

In the user information DB 14, for example, information relating to users each registered as a user that receives advertisement in the advertisement distribution system 100. For example, in the user information DB 14, e.g., user identification information, information relating to a vehicle and distributed advertisement information record information are stored in association with one another. The user identification information is, for example, identification information provided to the relevant user in the advertisement distribution system 100. The information relating to a vehicle includes, for example, vehicle identification information and a type of the vehicle. The vehicle identification information is, for example, an ETC card number or an automobile registration number indicated on a number plate. For example, expressway toll discount information is acquired based on the distributed advertisement information record information.

The respective functional configurations of the center server 1, the road-side apparatus 2 and the in-vehicle apparatus 4 illustrated in FIG. 3 are mere examples and these functional configurations are not limited to those illustrated in FIG. 3.

<Flow of Processing>

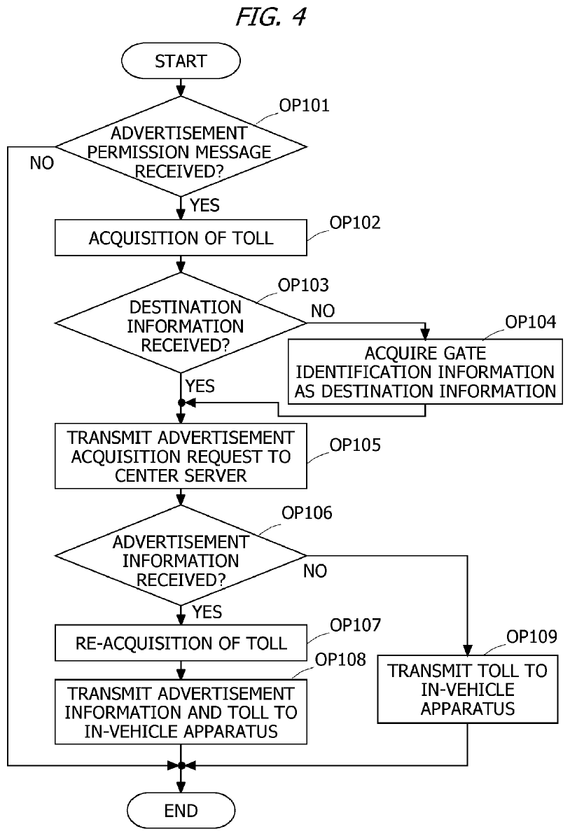

FIG. 4 is an example of a flowchart of processing in the road-side apparatus 2. The processing illustrated in FIG. 4 is repeatedly performed, for example, in a predetermined interval. Although an entity that performs the processing illustrated in FIG. 4 is the CPU 201 of the road-side apparatus 2, for sake of convenience, the processing will be described with a functional component as the entity.

In OP101, the control unit 24 determines whether or not an advertisement permission message has been received from an in-vehicle apparatus 4. Together with the advertisement permission message, entrance information, an ETC card number, vehicle information, user identification information, destination information and vehicle state information are received. If the advertisement permission message has been received (OP101: YES), the processing proceeds to OP102. If no advertisement permission message has been received (OP101: NO), the processing illustrated in FIG. 4 ends.

In OP102, the control unit 24 provides an instruction to calculate an expressway toll to the toll calculation unit 23 and acquires information of the expressway toll from the toll calculation unit 23.

In OP103, the control unit 24 determines whether or not destination information has been received from the in-vehicle apparatus 4. If destination information has been received from the in-vehicle apparatus 4 (OP103: YES), the processing proceeds to OP105. If no destination information has been received from the in-vehicle apparatus 4 (OP103: NO), the processing proceeds to OP104.

In OP104, the control unit 24 acquires gate identification information of an exit gate associated with the relevant apparatus as destination information.

In OP105, the control unit 24 outputs an advertisement acquisition request to the server communication unit 22 to transmit the advertisement acquisition request to the center server 1 through the server communication unit 22. Together with the advertisement acquisition request, the user identification information, the destination information and the vehicle state information are transmitted. Also, for example, if discount information is a discount rate, in order for the center server 1 to acquire information of a discount amount and acquire an advertisement fee for an advertiser, expressway toll information may be transmitted together with the advertisement acquisition request.

In OP106, the control unit 24 determines whether or not advertisement information and expressway discount information have been received from the center server 1. If advertisement information and expressway discount information have been received from the center server 1 (OP106: YES), the processing proceeds to OP107. For example, if neither advertisement information nor expressway discount information has been received from the center server 1 even after a lapse of a predetermined length of time from the transmission of the advertisement acquisition request in OP106 (OP106: NO), the processing proceeds to OP109. In OP109, the control unit 24 transmits the expressway toll calculated in OP102 to the in-vehicle apparatus 4 through the terminal communication unit 21. This is because even though no advertisement information can be delivered to the in-vehicle apparatus 4, notification of an expressway toll is provided. The predetermined length of time is, for example, a length of time that is longer than a total length of time taken for communications from the in-vehicle apparatus 4 to the road-side apparatus 2, from the road-side apparatus 2 to the center server 1, from the center server 1 to the road-side apparatus 2 and from the road-side apparatus to the in-vehicle apparatus 4 and is shorter than a length of time taken for the vehicle to exit from a range in which communication with the road-side apparatus 2 is possible when the vehicle travels at a predetermined speed. The predetermined speed is, for example, a highest speed of a speed range in which when a vehicle passes through an ETC gate, communication with a road-side apparatus 2 is possible. Subsequently, the processing illustrated in FIG. 4 ends.

In OP107, the control unit 24 re-acquires expressway toll information based on the discount information received from the center server 1. In other words, the control unit 24 acquires a discounted expressway toll. In OP108, the control unit 24 transmits information of the discounted expressway toll to the in-vehicle apparatus 4 through the terminal communication unit 21. Subsequently, the processing illustrated in FIG. 4 ends. Note that together with the expressway toll information to the in-vehicle apparatus 4 in OP108 and OP109, the expressway toll information is transmitted also to an expressway toll settlement server through the server communication unit 22. Note that the processing in the road-side apparatus 2 illustrated in FIG. 4 is a mere example and the present disclosure is not limited to this example.

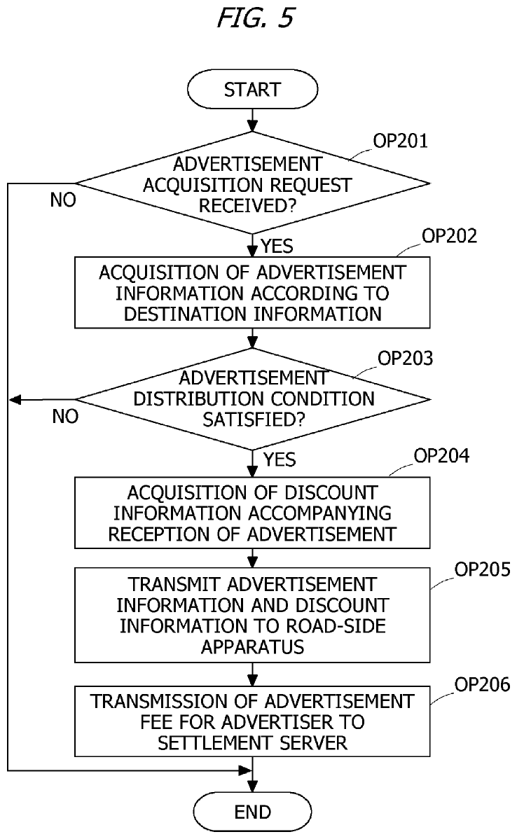

FIG. 5 is an example of a flowchart of processing in the center server 1. The processing illustrated in FIG. 5 is repeated, for example, in a predetermined interval. Although in FIG. 5, also an entity that performs the processing is the CPU 101 of the center server 1, for sake of convenience, description will be provided with a functional component as the entity.

In OP201, the control unit 12 determines whether or not an advertisement acquisition request has been received from a road-side apparatus 2. If an advertisement acquisition request has been received (OP201: YES), the processing proceeds to OP202. If no advertisement acquisition request has been received (OP201: NO), the processing illustrated in FIG. 5 ends. Together with the advertisement acquisition request, for example, user identification information, destination information and vehicle state information are acquired.

In OP202, the control unit 12 acquires advertisement information according to the received destination information from the advertisement information DB 13. For example, if information indicating a destination of the relevant vehicle is included in the destination information, the control unit 12 acquires advertisement information relating to a predetermined range including the destination. For example, if gate identification information of an exit gate the vehicle passes through is included in the destination information, the control unit 12 acquires advertisement information relating to a predetermined range positioned in a direction of exit from the exit gate.

In OP203, the control unit 12 determines whether or not the received vehicle state information satisfies an advertisement distribution condition. If the received vehicle state information satisfies the advertisement distribution condition (OP203: YES), the processing proceeds to OP204. If the received vehicle state information does not satisfy the advertisement distribution condition (OP203: NO), the processing illustrated in FIG. 5 ends.

In OP204, the control unit 12 acquires expressway toll discount information, for example, based on information of advertisement distribution records for the relevant user, which is included in the user information DB 14. In OP205, the control unit 12 transmits the advertisement information acquired in OP202 and the discount information acquired in OP204 to the transmission/reception unit 11 to transmit the advertisement information and the discount information to the road-side apparatus 2 through the transmission/reception unit 11. Also, the control unit 12 associates the advertisement information with the user identification information and stores the association as information of an advertisement distribution record in the user information DB 14.

In OP206, the control unit 12 acquires an advertisement fee for an advertiser of the advertisement information acquired in OP202, based on the discount information acquired in OP204 and transmits information of the advertisement fee to the advertisement fee settlement server. Subsequently, the processing illustrated in FIG. 5 ends. Note that the processing in the center server 1 illustrated in FIG. 5 is a mere example and the present disclosure is not limited to this example. For example, if the processing in OP206 is performed as batch processing to be performed, for example, once in a predetermined period of time, the processing in OP206 may be performed at a timing for the batch processing.

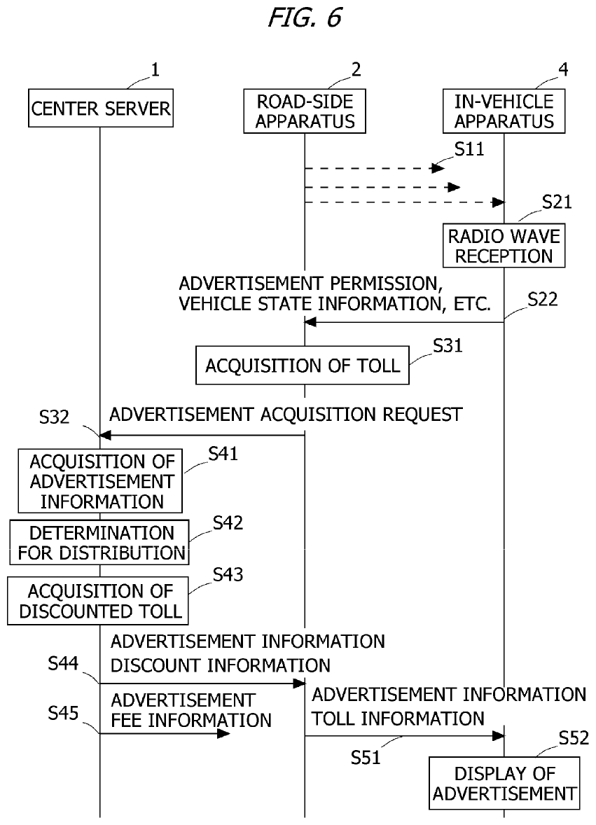

FIG. 6 is a diagram illustrating an example of a sequence of processing in the advertisement distribution system 100. In FIG. 6, it is assumed that an in-vehicle apparatus 4 is an in-vehicle apparatus mounted in a vehicle owned by a user registered so as to receive advertisement in the advertisement distribution system 100. Also, it is assumed that an advertisement distribution condition is that a speed of a vehicle is equal to or below a predetermined speed.

In S11, a road-side apparatus 2 transmits a signal including identification information of an exit gate in a predetermined interval. In S21, the in-vehicle apparatus 4 approaches an exit gate provided in the vicinity of the road-side apparatus 2 and receives the signal transmitted from the road-side apparatus 2. In S22, the in-vehicle apparatus 4 transmits an advertisement permission message, vehicle state information, destination information, entrance information, vehicle information, an ETC card number and user identification information to the road-side apparatus 2. However, in FIG. 6, the advertisement permission message and the vehicle state information are extracted and indicated. In FIG. 6, it is assumed that the in-vehicle apparatus 4 transmits a speed of the vehicle as the vehicle state information. Also, in S22, it is assumed that the speed of the vehicle is equal to or below the predetermined speed in the advertisement distribution condition.

In S31, the road-side apparatus 2 receives the advertisement permission message from the in-vehicle apparatus 4 (FIG. 4, OP101: YES), and acquires expressway toll information based on the entrance information and the vehicle information (FIG. 4, OP102). In S32, since the destination information has been received from the in-vehicle apparatus 4 (FIG. 4, OP103: YES), the road-side apparatus 2 transmits an advertisement acquisition request to the center server 1 (FIG. 4, OP105). Together with the advertisement acquisition request, the user identification information, the vehicle state information and the destination information are transmitted to the center server 1.

In S41, the center server 1 receives the advertisement acquisition request from the road-side apparatus 2 (FIG. 5, OP201: YES), and since the destination information received together with the advertisement acquisition request includes information indicating a destination, the center server 1 acquires advertisement information according to the destination (FIG. 5, OP202).

In S42, the center server 1 determines whether or not advertisement can be distributed to a vehicle corresponding to the user identification information received together with the advertisement acquisition request, that is, whether or not the vehicle state information received together with the advertisement acquisition request satisfies the advertisement distribution condition (FIG. 5, OP203). In FIG. 6, the speed of the vehicle with the in-vehicle apparatus 4 mounted therein is received as the vehicle state information and the advertisement distribution condition is that a speed of a vehicle is equal or below the predetermined value. Also, the speed of the vehicle transmitted from the in-vehicle apparatus 4 is equal to or below the predetermined value. Therefore, in S42, the center server 1 makes a determination to distribute advertisement to the in-vehicle apparatus 4 (FIG. 5, OP203: YES).

In S43, the center server 1 acquires expressway toll discount information accompanying reception of advertisement (FIG. 5, OP204). In S44, the center server 1 transmits the advertisement information and the discount information to the road-side apparatus 2 (FIG. 5, OP205). In S45, the center server 1 transmits information of an advertisement fee for an advertiser of the advertisement information distributed, which is based on the discount information acquired in S43, to a settlement server.

In S51, the road-side apparatus 2 receives the advertisement information and the expressway toll discount information from the center server 1 (FIG. 4, OP106: YES), acquires a discounted expressway toll based on the discount information (FIG. 4, OP107) and transmits information of the discounted toll and the advertisement information to the in-vehicle apparatus 4 (FIG. 4, OP108). In S52, the in-vehicle apparatus 4 causes the expressway toll information and the advertisement information received from the road-side apparatus 2 to be displayed on a display apparatus in the vehicle.

<Operation and Effects of the First Embodiment>

According to the first embodiment, when a vehicle passes through an exit gate of an expressway, if a state of the vehicle is regarded as a state in which safety can be ensured even if advertisement is distributed, advertisement information according to a destination of the vehicle is distributed to the vehicle. The distribution of the advertisement information according to the destination of the vehicle, that is, a place the vehicle is heading for enables drawing attention of occupants in the vehicle to the advertisement information and thus enhancing advertising effectiveness. In addition, the advertisement information is distributed if safety is regarded as being ensured, enabling ensuring safety of running of the vehicle. Also, the passage through the exit gate of the expressway is an event that draws attention of the occupants in the vehicle, and distribution of the advertisement information at the timing of the passage enables enhancement in advertising effectiveness. Also, since the exit gate of the expressway is located on a route to the destination, the advertisement information can be distributed at a good timing before arrival of the destination.

Also, according to the first embodiment, road-side apparatuses in an existing ETC system can be used as road-side apparatuses 2 and ETC in-vehicle apparatuses can be used as in-vehicle apparatuses 4, and in that case, costs for introduction of the advertisement distribution system 100 can be lowered. Also, the existing system can effectively be used. Furthermore, the use of the existing ETC system facilitates acquisition of detailed information on vehicles and users and thus facilitates research of advertising effectiveness.

### Other Embodiments

The embodiment described above is an example, and the present disclosure may be changed and carried out as appropriate without departing from the gist of the present disclosure.

Although in the first embodiment, an in-vehicle apparatus 4 acquires vehicle state information and transmits the vehicle state information to the center server 1 via a road-side apparatus 2, the method for acquiring vehicle state information is not limited to this example. For example, an in-vehicle apparatus 4 may notify the center server 1 of information that serves as materials for determining a vehicle state and the center server 1 may determine a vehicle state from the information to acquire vehicle state information. More specifically, for example, if the vehicle state information is a speed of the vehicle, the in-vehicle apparatus 4 may transmit a plurality of position information pieces acquired during a predetermined period of time before and after detection of the road-side apparatus 2, together with an advertisement permission message. The plurality of position information pieces may be transmitted from the center server 1 via the road-side apparatus 2 and the center server 1 may acquire the speed of the vehicle from the plurality of position information pieces. For example, if the vehicle state information is the number of users in the vehicle, the in-vehicle apparatus 4 may notify the center server 1 of information acquired by a predetermined sensor in the vehicle together with the advertisement permission message and the center server 1 may acquire the number of users in the vehicle from the information acquired by the predetermined sensor in the vehicle. The information acquired by the predetermined sensor is, for example, an image picked up by a camera, an angle of view of which is directed to the inside of the vehicle.

Alternatively, where a sensor such as a camera or a vehicle speed measurement instrument is installed at an exit gate together with a road-side apparatus 2, if an advertisement permission message has been received from an in-vehicle apparatus 4, the road-side apparatus 2 may acquire information acquired by the sensor (e.g., an image picked up by the camera or a value measured by the speed measurement instrument) and transmit the information to the center server 1 as vehicle state information, together with an advertisement acquisition request.

Also, although in the first embodiment an example has been described that when a vehicle passes through an exit gate of an expressway, advertisement is distributed, the technique described in the first embodiment is applicable to a case where when a vehicle passes through an entrance gate of an expressway, advertisement is distributed.

Also, although the first embodiment has been described in terms of a case where a vehicle passes through an exit gate installed at a toll booth of an expressway, applications of the technique described in the first embodiment are not limited to an exit or an entrance of an expressway. For example, the technique is applicable to an entrance gate or an exit gate of a toll parking.

Also, even where no gate is provided, the technique is also applicable to a predetermined area in which a road-side apparatus that records entry and exit of a vehicle and can communicate with the vehicle is installed. Also, the technique described in the first embodiment may be applied to, for example, an entrance for vehicles in a facility of a type in which a fee is paid at the time of entry.

Although in the first embodiment, advertisement information to be distributed from the center server 1 to a vehicle is transmitted to the relevant in-vehicle apparatus 4 via a road-side apparatus 2, if the center server 1 and the in-vehicle apparatus 4 can communicate with each other without a road-side apparatus 2, advertisement information to be distributed to the vehicle may be transmitted from the center server 1 to the in-vehicle apparatus 4 without a road-side apparatus 2.

Although in the first embodiment, advertisement information to be distributed from the center server 1 to a vehicle is transmitted to the relevant in-vehicle apparatus 4 and output on a display apparatus installed inside the vehicle, the present disclosure is not limited to this example. For example, the center server 1 may transmit advertisement information to a display apparatus located around the vehicle or an exit gate the vehicle passes through and cause the advertisement information to be output on the display apparatus.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor configured to:
acquire, when passage of a vehicle through an entrance or an exit of a toll road is detected, destination information relating to a destination of the vehicle and state information relating to a state of the vehicle;
select advertisement information to be distributed to the vehicle, based on the destination information;
determine whether or not a predetermined condition for ensuring safety of running of the vehicle is satisfied, based on the state information; and
distribute, when the predetermined condition is satisfied, the advertisement information to the vehicle.

2. The information processing apparatus according to claim 1, wherein
the state information includes a speed of the vehicle; and
the predetermined condition is that the speed of the vehicle is equal to or below a predetermined value.

3. The information processing apparatus according to claim 1, wherein
the state information includes the number of occupants in the vehicle; and
the predetermined condition is that two or more occupants are in the vehicle.

4. The information processing apparatus according to claim 1, wherein
the vehicle is an autonomous vehicle;
the state information includes information indicating whether or not the vehicle is in automatic operation; and
the predetermined condition is that the vehicle is in automatic operation.

5. The information processing apparatus according to claim 1, wherein the processor is configured to select advertisement information related to a predetermined range including the destination indicated by the destination information, as the advertisement information to be distributed to the vehicle.

6. The information processing apparatus according to claim 1, wherein
the destination information includes identification information of the exit the vehicle passes through; and
the processor is configured to select advertisement information related to a predetermined range positioned in a direction of exit from the exit the vehicle passes through, as the advertisement information to be distributed to the vehicle.

7. An information processing system comprising:
a road-side apparatus installed at an entrance or an exit of a toll road or a facility, the road-side apparatus being configured to perform predetermined wireless communication with an in-vehicle apparatus in a vehicle passing through the entrance or the exit; and
a server,
wherein the server includes a processor configured to:
acquire, when passage of the vehicle through the entrance or the exit is detected via the wireless communication between the road-side apparatus and the vehicle, destination information relating to a destination of the vehicle and state information relating to a state of the vehicle;
select advertisement information to be distributed to the vehicle, based on the destination information;
determine whether or not a predetermined condition for ensuring safety of running of the vehicle is satisfied, based on the state information; and
distribute, when the predetermined condition is satisfied, the advertisement information to the vehicle.

8. An advertisement distribution method comprising:
acquiring, when passage of a vehicle through an entrance or an exit of a toll road is detected, destination information relating to a destination of the vehicle and state information relating to a state of the vehicle;
selecting advertisement information to be distributed to the vehicle, based on the destination information;
determining whether or not a predetermined condition for ensuring safety of running of the vehicle is satisfied, based on the state information; and
distributing, when the predetermined condition is satisfied, the advertisement information to the vehicle.
